(19) United States
(12) Patent Application Publication
(10) Pub. No.: US 2015/0277563 A1
(43) Pub. Date: Oct. 1, 2015

(54) DYNAMIC TACTILE USER INTERFACE

(71) Applicants: Wen-Ling M. Huang, Los Altos, CA (US); Giuseppe Raffa, Portland, OR (US); Glen J. Anderson, Beaverton, OR (US)

(72) Inventors: Wen-Ling M. Huang, Los Altos, CA (US); Giuseppe Raffa, Portland, OR (US); Glen J. Anderson, Beaverton, OR (US)

(21) Appl. No.: 14/229,577

(22) Filed: Mar. 28, 2014

(51) Int. Cl. G06F 3/01; G06F 3/0487

(52) U.S. Cl. CPC G06F 3/016; G06F 3/0487

(57) ABSTRACT

Systems and methods may provide for a programmable array of tactile elements in which the active elements may be dynamically altered in time and space and in dependence upon the orientation of the device of which it is a part. That device may be part of a wearable device, such as a hat, smart watch, smart glasses, glove, wristband or other garment.

### BACKGROUND

Wearable electronic devices such as smart watches, smart glasses, and wristbands may have displays and user interfaces. In use, the user typically moves some part of his body to bring the wearable device into some useable position. For example, a wrist watch is generally used with the user orienting his wrist so that the face of the watch comes into view. Such user movements may not be convenient.

A user interface may have a tactile, i.e., a haptic component, so that it may be perceived through the sense of touch. The simplest sort of haptic is an ordinary protruding button made of a rigid material like metal or hard plastic. In this sense, the keys of a typewriter, with their typically deep range of travel, may be seen as having a tactile component. Such an approach may not be suitable for integration into modern displays, where a much lower and less obtrusive profile is called for in addition to optical considerations. Even so, the tactile value of having protruding keys may be substantial.

### BRIEF DESCRIPTION OF THE DRAWINGS

The various advantages of the embodiments will become apparent to one skilled in the art by reading the following specification and appended claims, and by referencing the following drawings, in which:

FIG. 1A is a perspective view of an example of an embodiment having the general form of a wristband;

FIGS. 1B and 1C are top and bottom views respectively of an example of an embodiment having display areas;

FIGS. 2A-2E show various wearable devices according to embodiments;

FIG. 3 is a block diagram of an example of an architecture to provide dynamic control of tactile elements according to an embodiment;

FIG. 4A is a plan view of an example of a portion of a tactile interface according to an embodiment in which selected tactile elements have been activated;

FIG. 4B is a plan view of an example of a portion of a tactile interface according to an embodiment in which selected tactile elements have been activated to form a smiley face;

FIG. 5 is a block diagram of an example of elements of an embodiment having GPS and orientation awareness;

FIG. 6 is a flowchart of an example of a method of using positional awareness according to an embodiment;

FIG. 7 is a partial cross sectional view of an example of a tactile element utilizing a solenoid according to an embodiment;

FIG. 8 is a view of an example of a tactile element utilizing fluidics and a block diagram of a control system according to an embodiment;

FIGS. 9A and 9B are schematic planar views of examples of linear rows of tactile elements according to embodiments;

FIG. 10 is a schematic cross sectional view of an example of a group of tactile elements using fluidics according to an embodiment, the accompanying insert showing a top plan view of this example;

FIG. 11 is a block diagram of an example of a processor according to an embodiment; and

FIG. 12 is a block diagram of an example of a system according to an embodiment.

### DETAILED DESCRIPTION

As used herein, the term “tactile element” may refer to an element providing tactile feel when it is used, i.e., touched or depressed. In general terms, when a tactile element has been activated, it may assume a characteristic that enables a user to differentiate it from the surrounding area. In one embodiment, this may be accomplished by extending a portion of the element beyond its immediate neighboring area when activated. In one embodiment, the tactile element may include a diaphragm overlying a cavity that may be filled with a fluid, causing the diaphragm to bulge outwardly when the tactile element is energized, giving it a bubble-like “button” shape and feel to the touch. When the tactile element is de-activated and returned to its resting state, fluid flows out of the cavity, causing it to deflate and then tactile element has a feel that is largely the same as the surrounding area of the device.

Tactile elements may be grouped into rows, columns, arrays, concentric circles or any other shape that is suitable for the embodiment in which it is used. They may range from sub-millimetric in size to dimensions in excess of centimeters or more. In embodiments in which fluidic inflation is used, they are generally round and may herein be referred to as “buttons”. In other embodiments they may be rectangular, pin-like or have any other shape.

Several embodiments disclosed herein are presented in the context of wearable devices. As used herein, the term “wearable device” (or simply a “wearable”) includes clothing and accessories incorporating computer or other such electronic technologies. Examples of a wearable device also may include apparatus containing electronic processors that are arranged to be worn by a person and integrated into a wearable structure such as a wristband, glove, ring, eyeglasses, belt-clip or belt, arm-band, shoe, hat, shirt, undergarment, outer garment, clothing generally, and additionally fashion accessories such as wallets, purses, umbrellas etc. In embodiments, a wearable device may be implemented as including all or part of the functional capability of a smart phone or tablet computer or gaming device capable of executing computer applications, as well as voice communications and/or data communications.

The term “smart” as an adjective before a noun, such as “smart watch” or “smart glasses”, “smart wrist band”, etc., includes devices that have one or more capabilities associated with smart phones, such as geo-location capability, the ability to communicate with another device, an interactive display, multi-sensing capabilities or other feature. The wearable may be a so-called smart device, in that it has access to one or more of the capabilities now common with smart phones, including geo-location, sensors, access to the internet via Wi-Fi (Wireless Fidelity, e.g., Institute of Electrical and Electronics Engineers/IEEE 802.11-2007, Wireless Local Area Network/LAN Medium Access Control (MAC) and Physical Layer (PHY) Specifications), near field communications, Bluetooth (e.g., IEEE 802.15.1-2005, Wireless Personal Area Networks) or other communication protocol. Such access may be direct or it may be via a Bluetooth connection with a nearby smart phone or a wearable device worn elsewhere on the user's person. A wearable device may have an interface with which a user interacts.

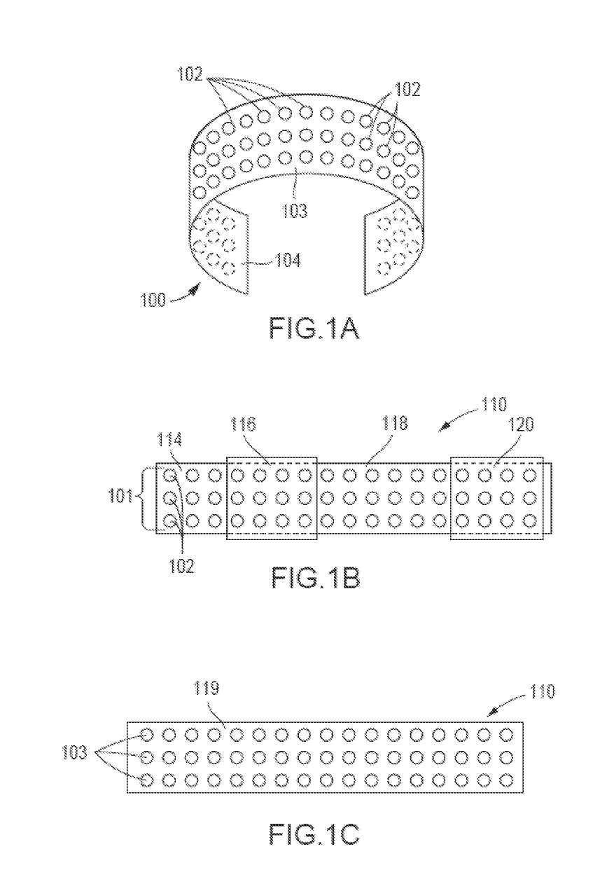

FIG. 1A shows a wearable wrist band 100 that may have a generally curved appearance when worn. Arrayed along the outer surface 103 of the wrist band 100 are rows and columns of individual tactile elements 102 forming an array. The tactile elements may, as is shown here, cover substantially the entire outer surface 103 of the wrist band 100, or be limited to some fraction of that surface. FIG. 1B shows the top, or upper side of an example of an embodiment of a wearable wrist band 110 that has been laid out flat for illustrative purposes, although the band may be curved or made of flat, linked segments. In this embodiment, the wrist band 110 includes two display portions 116 and 120, and two non-display portions 114 and 118. Arrayed along substantially the entire outer (top) surface 114, 116, 118, and 120 are tactile elements 102 that constitute an interface through which a user may interact with the device. In other embodiments these tactile elements may be excluded from the display area(s). FIG. 1C shows the bottom, or inner surface 119 of the wrist band 110, along which there are no display sections. The inner surface 119, which would normally be worn facing the user's skin, may include rows of tactile elements 103 arrayed along substantially the full length of the wrist band. Tactile elements 103 may be identical to the tactile elements 102 provided on the outer surface 118, or they may differ, and have different capabilities (such as tactile effect, size, sensor capability etc.). Alternatively, one side may be provided with tactile elements whereas the other side has none.

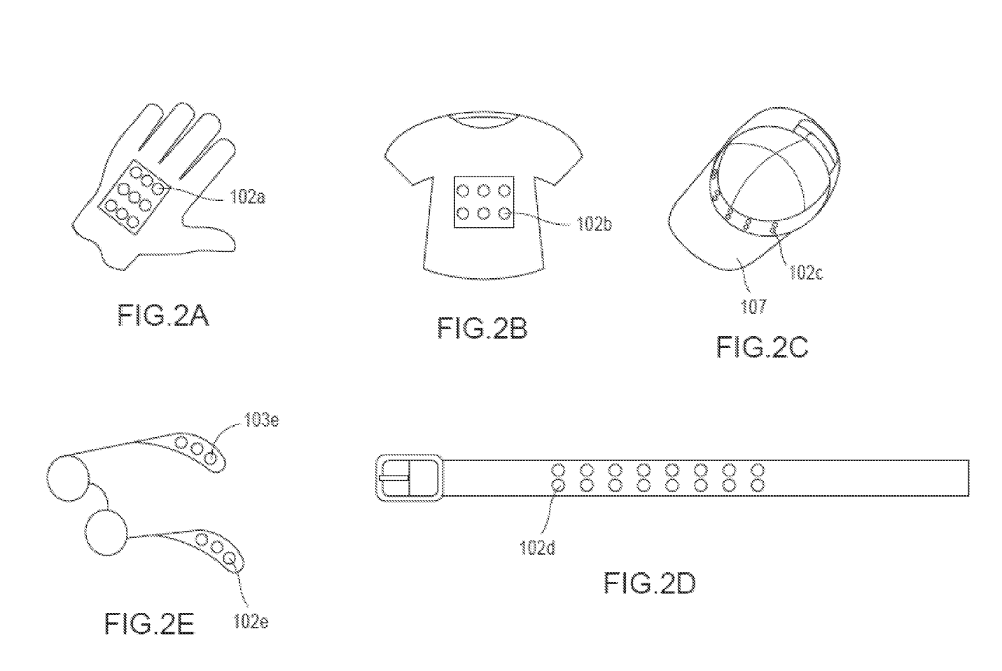

FIGS. 2A-2D show a variety of examples of wearables that have tactile elements integrated therewith, and as above, these may be provided only on inwardly facing surfaces, or only on outwardly facing surfaces, or both. These embodiments include a glove (FIG. 2A), shirt (FIG. 2B), cap (FIG. 2C, shown with inwardly facing tactile elements arrayed along a head band that in use faces the user's forehead), and belt (FIG. 2D). FIG. 2E depicts a pair of smart glasses in which tactile elements are provided on both sides of the temple elements. The tactile elements of these embodiments may be felt by touch when they have been activated and differentiated from areas of the wearable that either have no tactile elements or whose tactile elements have not been activated.

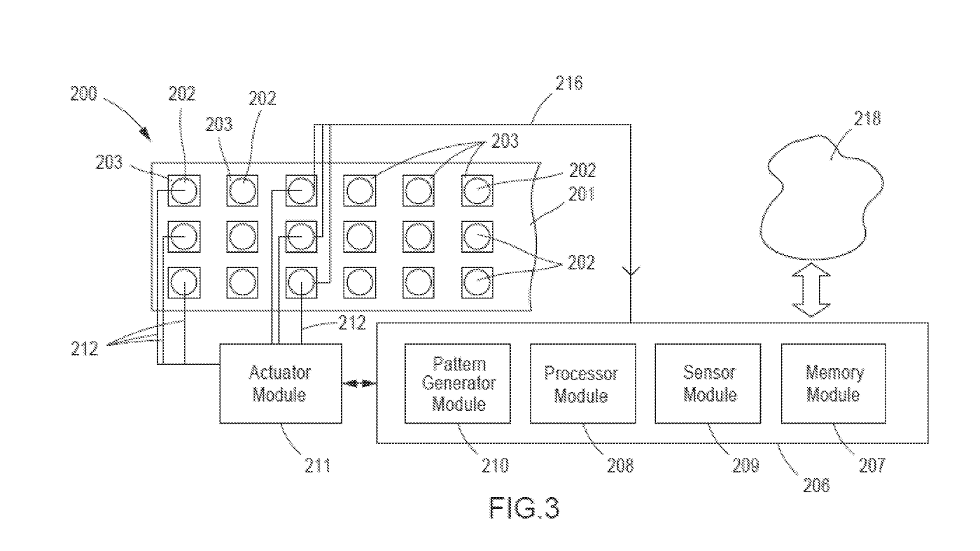

FIG. 3 is a block diagram 200 of an example of an architecture for providing dynamic control over an array of tactile elements and through which a user interface may be established. A portion of one side of a wearable 201 is provided with three rows (there may be more or fewer rows) of tactile elements 202. Associated with each tactile element 202 is a corresponding sensor and/or switching element 203 responsive to pressure or temperature such as is characteristic of touch by a user's finger, or any other physical variable that may be associated with a user that may be brought into proximity with the sensors. The tactile elements 202 in this example overlie the sensor or switching elements 203, although this order may be reversed. In this example, each tactile element 202 is individually addressable and controllable via lines 212. In other embodiments, control may be over less granular groups of tactile elements, such as rows or columns or portions thereof. Additionally, each sensor/switch 203 may have a return line 216.

A control module 206 directs an actuator module 211 to activate, via control lines 212, one or more tactile elements 202. The particular nature of the actuator module will depend on the specific implementation of tactile element used. For example, if the tactile elements are implemented as fluidicly activated buttons, then the actuator module may include at least one pump, which may be bidirectional, and may also include fluidic logic in the form of valves and fluid circuits to permit the selective activation and deactivation of individual or groups of tactile elements. It may also include a reservoir of hydraulic fluid. In such an example, the control lines 212 use pressurized fluid. In another example, the tactile elements may be based on solenoids, the actuator module may include electrical circuitry to selectively activate and deactivate desired tactile elements via control lines 212 that are electrically conductive. The control lines 212 in this example are electrically conducting wires. Whatever the specific form of tactile element used, the actuator module 211 may activate a specific physical pattern of tactile elements 202.

In this example, the physical pattern identifies specific tactile elements 202 for activation. It may be generated within the control module 206, which may include a memory module 207, a processor module 208, a sensor module 209, and a pattern generator module 210. The memory module 207 may store context information and rules, pre-set logical patterns of activations, applications and application data, and sensor data. The processor module 208 processes any or all of this information, resulting in the generation of a logical pattern of tactile element activations. This logical pattern is turned into (i.e., maps onto) a physical pattern of activations at the pattern generator module 210. Sensor module 209 may include and process device location and orientation data, such as may be provided by GPS sensors.

The control module may be linked via any wireless or wired protocol to network 218, which may be part of a Local Area Network (LAN), Wide Area Network (WAN), the cloud, the Internet, cellular network, Wi-Fi, and so forth. Thus, the control module may be responsive to communications received from another device or network, near or far.

In use, the user applies pressure to the activated tactile elements 202 (which, in the examples of the solenoid or fluidics embodiments, would be protruding when activated), causing switching or other sensory input into the associated sensors or switches 203. These sensor or switch elements 203 then send signals conveying information via lines 216 to the control module 206, providing feedback and/or other data, although open loop control may be practiced in other examples. After a predetermined time interval, the tactile elements 202 are de-activated for later re-use, and they return to their initial configuration in which they feel generally flush with the surrounding area.

In alternative embodiments the memory module 207, processor module 208, sensor module 209 and pattern generator module 210 may be combined into fewer modules.

All of these components may be integrated into the wearable device, or some parts of them such as the control module 206 or parts thereof may be located in another device with which the wearable in communication, such as a smart phone, another wearable, or the cloud.

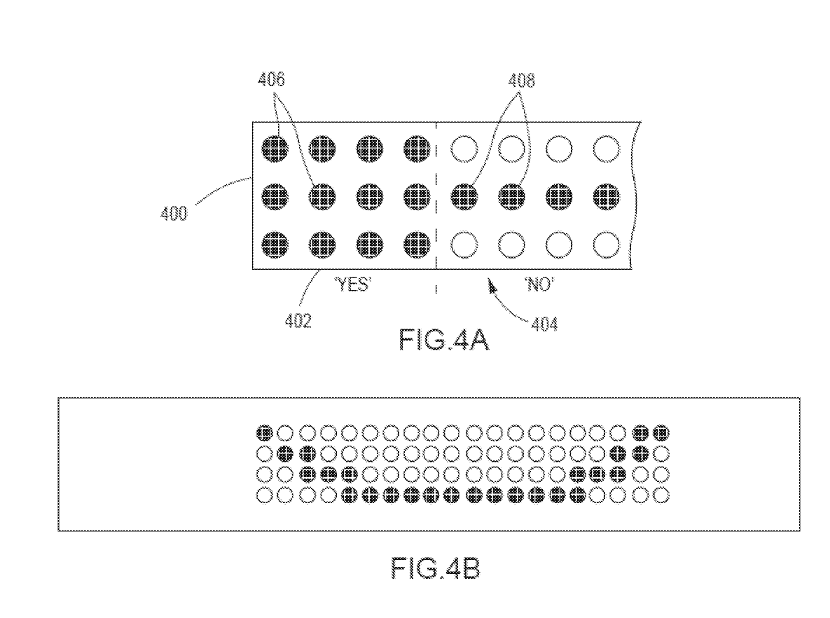

Embodiments disclosed herein provide for a dynamically programmable array of tactile elements in which a physical pattern of tactile elements to be placed into an activated or a de-activated state may be based on a logical pattern of tactile elements. Each of these patterns may be varied as per the needs of the user and/or the requirements of whichever application the user may be running at a given time, and over any portion of the wearable a product designer may feel best suits the interface design. For example, an application may draw attention to a user by triggering an alarm that indicates to the user that he is to respond via the user interface by selecting from one of two possibilities: “YES” or “NO” (FIG. 4A). The control module 206 may direct that one sub-array of tactile elements is activated to form a first block 402 of raised buttons 406 (shaded in the figure) associated with a “YES” response, while a second block 404 of raised tactile elements 408 (also shaded in the figure) is associated with a “NO” response. A user would then reach for the interface surface, where he would be able to readily discern and identify each of these two blocks, as most people may generally tell the difference between these two patterns of raised buttons without having to see them with their eyes. In the instant embodiment, the user would register his response on the interface by pressing down on one or more buttons from the desired group, thereby sending signals along sensor/switch lines 216 to the control module 206 where the response would be interpreted as “YES” or “NO.”

The flexibility provided by the programmability of the array permits a designer broad scope in crafting user interfaces. For example, a number of tactile elements may be activated together to form a larger button for the benefit of users with larger fingers. In another embodiment, tactile elements may be grouped in fanciful patterns, e.g. so as to form a smile for the user to touch (FIG. 4B).

Tactile elements such as buttons need not be located on the outer surface of the device but may, in other embodiments, be located on an inner surface or both surfaces. Thus, a user may be signaled information based on a perceptible pattern of button activations felt against his person (at the wrist, in the case of a wristband or other wrist wearable), and then respond to that message by touching the buttons on the outer surface. In such an embodiment, inner and outer provided arrays may be independently controllable (i.e., independently addressable), and in some embodiments the inner array may be provided without any switches, as the user would not be able to reach them there.

A plurality of wearable devices employing embodiments may be provided with wireless communications capability with one another either directly or via a network so that individual users may communicate with one another through the wearable devices. Such an approach may be of use in game play, where users communicate with one another via their wearable devices through the patterns of activated buttons formed thereon.

According to another embodiment, the inner surface may be provided with a sensor array that collects information about the state or context of the person, including temperature sensors that determine user body temperature, pressure sensors for blood pressure, sensors that measure pulse rate, and electrical sensors that pick up myoelectric activity. This information may then be used by the control module to activate patterns of tactile elements on the outer surface of the wearable. For example, an elevated pulse rate might indicate that the user is in a physical or psychological state in which the user is not as able to detect or notice raised tactile elements as when the user is in a resting, calm state. In such a situation, larger, and thus more readily perceivable, groups of tactile elements may be activated to compensate for the particular context of the user.

Embodiments may make use of GPS coordinates or other geo-location techniques to vary the nature or content of the pattern of tactile elements activated on a wearable. FIG. 5 is a block diagram of a wearable 500 that has a processor 510, a gyroscope 520, an accelerometer 530, a magnetometer 540, and a sensor array 550. The processor 510 may be separate from the wearable, such as in another device with which the wearable in communication. These elements may be used with a GPS or other geo-location system to provide indication of the location of the wearable and thus also of the user wearing it. This information may be used to vary the pattern of tactile elements to be activated with user location or to provide indication of location to the user by way of the interface of tactile elements. For example, accelerometer data may determine whether the user is standing still or engaging in exercise (e.g., running, or swinging an arm). In the exercise context, the user's sense of touch may be less acute than when the user is standing still, and larger groups of adjacent tactile elements may be activated to make them collectively bigger or otherwise easier for the user to feel.

In the wearable cap embodiment depicted in FIG. 2C, a cap 105 is provided with an array of tactile elements 102c integrated into an inwardly facing headband 107 of the cap 105, which in use rests against the wearer's forehead. By using a Bluetooth connection to link the cap 107 to a nearby smart phone, incoming calls may be announced by activating buttons 102c along the headband 107 cap resting against the user's forehead, where touch sensitivity is acute. Since the activation of buttons is under processor control, many geometrically and temporally varying patterns may be used to specify the identity of the caller. Moreover, the array may be programmed to create arrows of moving buttons in response to GPS-based commands, either using GPS capabilities build into the wearable or associated with some other device (such as a smart phone) with which the wearable is in communication via Bluetooth or other technology. In the manner of a moving “zipper” of light elements in a sign, a time and spatially varying pattern of cascading activations may be set up signifying basic directional commands like “go left” and “go right” that would be felt on the user's forehead. These commands may be used for guidance in instructing the user on how to walk or drive to a destination.

In another embodiment, the cascade may be along a generally circular path, with clockwise patterns of activations indicating “go right” and counterclockwise patterns of activations indicating “go left.” The pattern of activated buttons may be along an inner surface that the user feels on his skin (e.g., for a wrist band, the user's wrist, or in the example of a hat, the user's forehead), or along an outer surface, or both, depending on how a given user interface is implemented. In addition to directional information, this embodiment may be used to convey other sorts of information to the user, including text.

Mechanisms and sensors generally provided for use with GPS systems may also be used to determine device orientation and with it, the orientation of any interface linked to the device. Accelerometers, gyroscopes, and magnetometers are in wide use in smart phones for providing data for use with GPS systems, and may also be used to determine device orientation by various well known standard techniques.

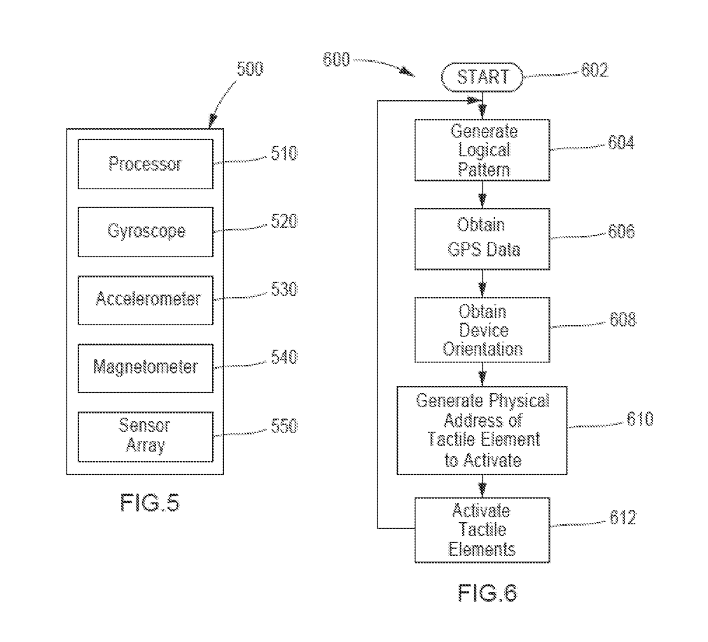

The operation of one embodiment is further addressed by way of reference to the flow chart 600 in FIG. 6. The method 600 may be implemented as a module in set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 300 may be written in any combination of one or more programming languages, including an object oriented programming language such as Java, Smalltalk, C++ or the like and conventional procedural programming languages, such as the “C” programming language or similar programming languages.

Again referring to flow chart 600 in FIG. 6, at starting block 602, the user or an application initiates a request that a logical pattern of activated tactile elements be generated at illustrated block 604. GPS data may be obtained at block 606 and at block 608 the orientation of the device may be determined. A physical pattern of tactile element activations is generated at illustrated block 610, but now with an orientation that reflects the device orientation. Control then passes back to 604, and should the device orientation or logical pattern have changed, so too will the identity of the particular tactile elements that are subsequently activated to form the physical pattern of activated tactile elements.

Such orientation awareness permits the desired pattern of tactile element actuation to be dynamically moved across the face of the tactile element array in dependence upon the orientation of the wearable device. Thus, in one embodiment, the activation of tactile elements corresponding to the YES/NO example set forth above may be dynamically shifted along the band so that these buttons would always be arranged along the “face up” portion of the wearable or in any other orientation that would be most convenient for the user. The user would not have to contort himself into an inconvenient position in order to touch the array. Also, the user may not then have to look at the array, but may reach for the buttons of interest at a preferred orientation, either selected by himself or by the interface designer.

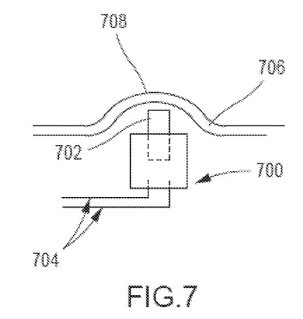

A number of different technologies may be used in the implementation of the tactile elements used in these embodiments. FIG. 7 shows a solenoid arrangement in which a solenoid 700 having an electromagnetically extensible pin 702 may be activated by electricity supplied from the controller by wires 704. When extended, the pin may be felt directly by a user or it may be used to push against an overlying polymer layer 706 so as to create a bulge 708.

Another approach is to use fluidics to control and activate tactile elements. In one embodiment, the tactile elements are provided as an array of buttons formed of a substrate attached to a button membrane, thereby creating a set of round, button cavities. The button cavities may be configured to be inflated and deflated by a pump coupled to a fluid reservoir. The cavities may be inflated/deflated together, in subsets, and/or individually. In some embodiments, the buttons may be sandwiched between a touch sensing layer and a display of a touch screen. In other embodiments, the button array may be located either above or below the touch screen.

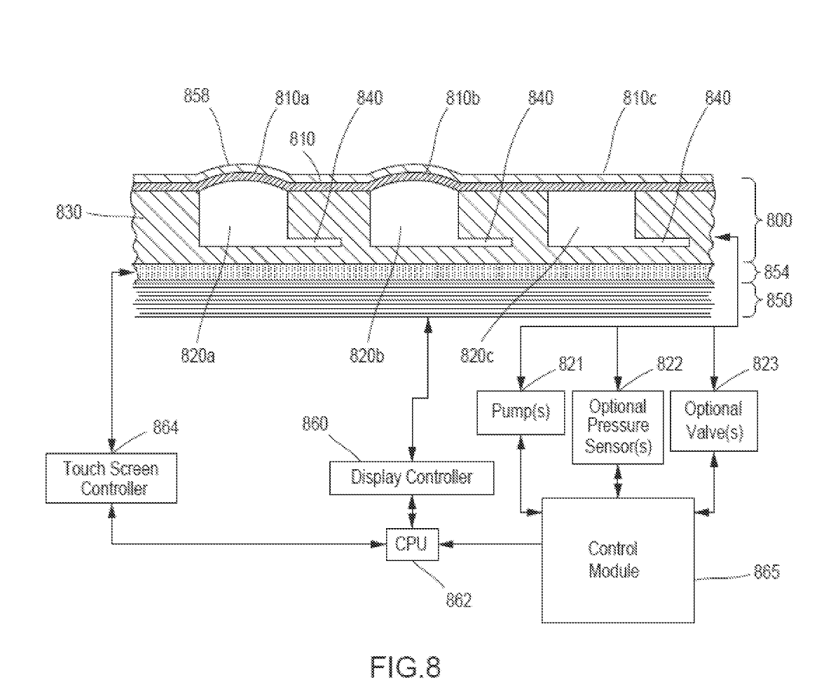

Such an embodiment is shown in FIG. 8. A button array 800 includes a substrate 830 and an overlying membrane 810 which are coupled to each other to form one or more enclosed cavities 820a, 820b, and 820c and overlying membrane portions 810a, 810b, and 810c. Substrate 830 may be made from a suitable optically transparent material including elastomers. In some embodiments, substrate 830 is a single homogenous layer approximately 1 mm to 0.1 mm thick and may be manufactured using well-known techniques for micro-fluid arrays to create one or more cavities and/or micro channels.

Membrane 810 may be made from a suitable optically transparent and elastic material including polymers or silicon-based elastomers such as poly-dimethylsiloxane (PDMS) or polyethylene terephthalate (PET).

Enclosed cavities 820a, 820b, and 820c, formed between substrate 830 and membrane 810, are fluid tight and coupled via fluid channel 840 to one or more fluid pumps (not shown in this figure). The pump(s) may either be internal or external with respect to a touch screen assembly incorporating button array 800.

In embodiments in which fluidic buttons overlie a display screen, to minimize optical distortion, the refractive index of the button fluid should be substantially similar to that of substrate 830 and also membrane 810. Depending on the application, suitable fluids include water and alcohols such isopropanol or methanol.

When selected buttons of the button array 800 need to be activated, i.e., raised or in other words inflated, fluid pressure inside specific cavities—here 820a and 820b—is increased thereby causing the overlying membrane portions 810a and 820b to be raised. In this example, the third cavity, 820c is not pressurized, and its overlying membrane 810c remains flat. In this example which is suitable for a handheld device, cavities 820 may have a cavity diameter of approximately 5 mm and membrane 810 is approximately 100 microns thick. Conversely, when button array 800 needs to be deactivated, fluid pressure inside the cavities is decreased thereby causing them to deflate and their corresponding overlying membrane portions (in this instance, 810a and 820a) to return to their original flat profile. It is contemplated that a button fluid pressure of approximately 0.2 psi and a button fluid displacement of about 0.03 ml should be sufficient to raise selected membrane (button) portions of 810 by about 1 mm.

A further feature of this embodiment is that it may be located atop a touch display screen 850 and may include a touch sensing layer 854. According to another embodiment, the touch display screen 850 may include sensors that provide input capability thereby eliminating the need for sensing layer 854.

An optional feature of this embodiment is the inclusion of an infrared sensor layer 858 to provide for finger proximity detection. The buttons are provided with infrared sensors in layer 858 so that they are able to sense the temperature of a finger approaching the buttons, enabling them to be inflated just moments before actual contact is made. This is advantageous in some circumstances where it may be used because activating a button uses energy, and by limiting the time that the buttons are activated to the typically brief interval when the user's fingers are nearly touching the buttons until after they have left them reduces power consumption. According to an additional embodiment, there may be a vibration to alert the user to the presence of some incoming message or other information awaiting his response. Then when the user approaches the buttons, select buttons are activated.

A vibration alert feature may be used in another embodiment to indicated the arrival of information. In these embodiments, the user first perceives vibration, which he takes to be a sign to touch the interface. Contacting the interface then causes the desired pattern of buttons to be activated. In an alternative embodiment, a bell may be sounded to indicate the presence of information at the interface instead of a vibration.

Embodiments may be utilized in gaming, such as by providing an interface for game play that is worn on the wrist, head, or other portion of the player's person. Such wearable devices may utilize either inner, outer, or both inner and outer arrays of activatable buttons.

FIG. 8 also presents an example of a control system for fluidic buttons/tactile elements according to an embodiment. The example may include a display controller 860 coupled to a display screen 850 and a central processing unit 862, and a touch screen controller 864 coupled to touch sensing layer 854 to determine when a button has been pushed. Activation of the buttons is controlled by control module 865 (which may be similar to the control module 206 of FIG. 3). The control module 865 creates a logical pattern of activations that is implemented physically by one or more pumps 821 (which may be bidirectional) sending pressurized fluid into selected button cavities 820a, 820b, and 820c as set forth above. Depending on the implementation, device 800 may also include fluid pressure sensor(s) 822 and valve(s) 823 coupled to pump(s) 821.

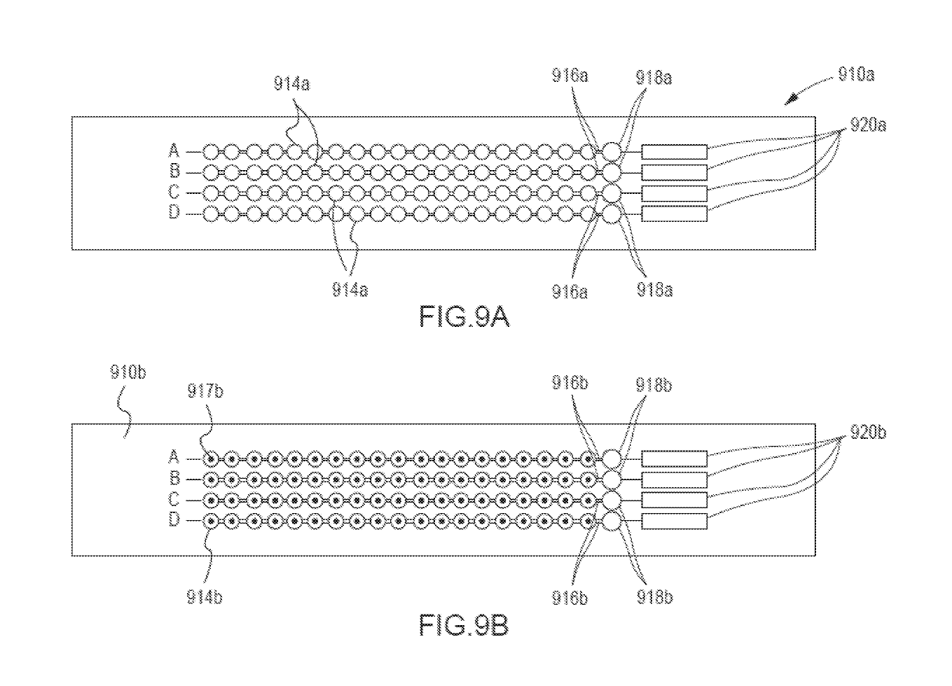

In some embodiments, not every tactile element may be individually activatable, but may instead be activated in more granular groups. For example, in the embodiment 910a shown in FIG. 9A, the tactile elements are fluidically activated buttons 914a that are strung along rows A, B, C and D. In each row, the buttons are connected by fluidic channel 916a to a bidirectional pump 918a and a fluid reservoir 920a. In this embodiment, entire rows are activated at a time. In the embodiment of FIG. 9B, by providing each bubble with its own valve 917b, finer levels of granularity of control may be obtained, as smaller groups of buttons may be activated at a time, depending on the complexity of the valving and fluidic channels provided.

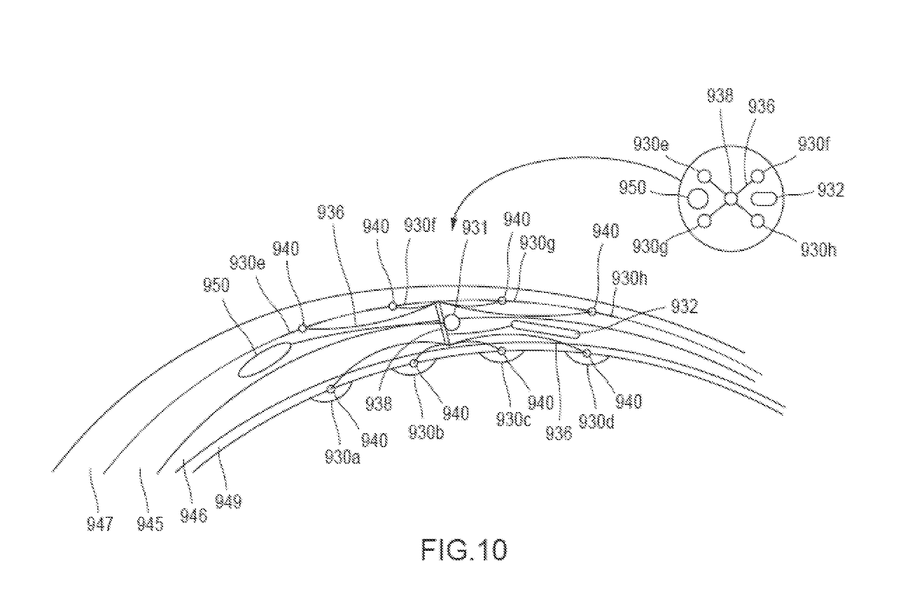

In the embodiment of FIG. 10 the buttons 930a-930h are individually activatable, but they are grouped in a radial pattern around a central point on each side. The buttons on both the top and bottom sides are connected via fluidic lines 936 to a central fluid channel 938 that has its own pump and value unit 931, and a central fluid reservoir 932 that may be integrated into the touch sensor layer 946. Also, each button has its own pump and valve unit 940. The pumps may optionally be powered by a battery 950 integrated into touch sensor layer 946 that is sandwiched between a cover layer 947 and a structure layer 946, which itself has a cover layer 949. In this figure, the bottom side buttons 930a-930d have been inflated, whereas the top side buttons 930e-h are flat.

In various embodiments, the wearable user interface may be implemented as a wireless system, a wired system, or a combination of both. When implemented as a wireless system, embodiments may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, embodiments may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

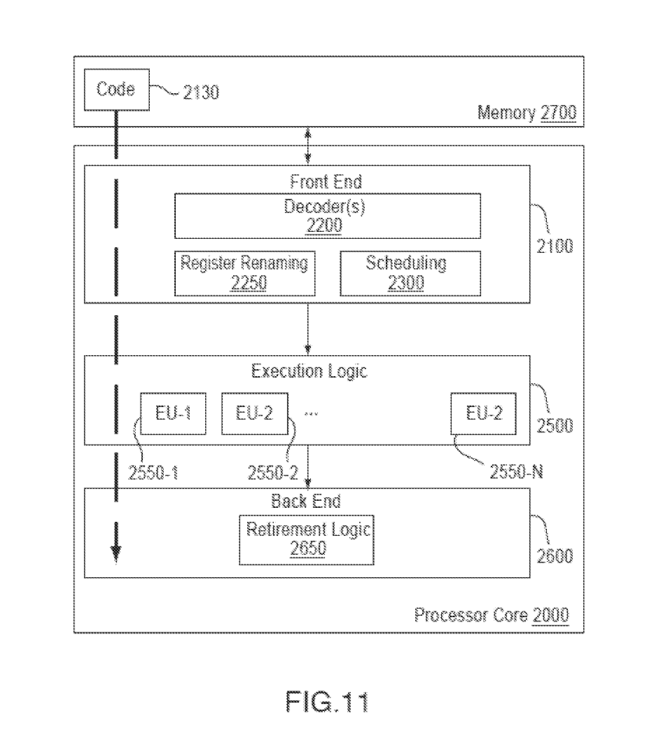

FIG. 11 illustrates a processor core 2000 according to one embodiment. The processor core 2000 may be the core for any type of processor, such as a micro-processor, an embedded processor, a digital signal processor (DSP), a network processor, or other device to execute code. Although only one processor core 2000 is illustrated in FIG. 11, a processing element may alternatively include more than one of the processor core 2000 illustrated in FIG. 11. The processor core 2000 may be a single-threaded core or, for at least one embodiment, the processor core 2000 may be multithreaded in that it may include more than one hardware thread context (or “logical processor”) per core.

FIG. 11 also illustrates a memory 2700 coupled to the processor core 2000. The memory 2700 may be any of a wide variety of memories (including various layers of memory hierarchy) as are known or otherwise available to those of skill in the art. The memory 2700 may include one or more code 2130 instruction(s) to be executed by the processor core 2000, wherein the code 2130 may implement the method (e.g., illustrated in FIG. 6), already discussed. The processor core 2000 follows a program sequence of instructions indicated by the code 2130. Each instruction may enter a front end portion 2100 and be processed by one or more decoders 2200. The decoder 2200 may generate as its output a micro operation such as a fixed width micro operation in a predefined format, or may generate other instructions, microinstructions, or control signals which reflect the original code instruction. The illustrated front end 2100 also includes register renaming logic 2250 and scheduling logic 2300, which generally allocate resources and queue the operation corresponding to the convert instruction for execution.

The processor core 2000 is shown including execution logic 2500 having a set of execution units 2550-1 through 2550-N. Some embodiments may include a number of execution units dedicated to specific functions or sets of functions. Other embodiments may include only one execution unit or one execution unit that may perform a particular function. The illustrated execution logic 2500 performs the operations specified by code instructions.

After completion of execution of the operations specified by the code instructions, back end logic 2600 retires the instructions of the code 2130. In one embodiment, the processor core 2000 allows out of order execution but requires in order retirement of instructions. Retirement logic 2650 may take a variety of forms as known to those of skill in the art (e.g., re-order buffers or the like). In this manner, the processor core 2000 is transformed during execution of the code 2130, at least in terms of the output generated by the decoder, the hardware registers and tables utilized by the register renaming logic 2250, and any registers (not shown) modified by the execution logic 2500.

Although not illustrated in FIG. 11, a processing element may include other elements on chip with the processor core 2000. For example, a processing element may include memory control logic along with the processor core 2000. The processing element may include I/O control logic and/or may include I/O control logic integrated with memory control logic. The processing element may also include one or more caches.

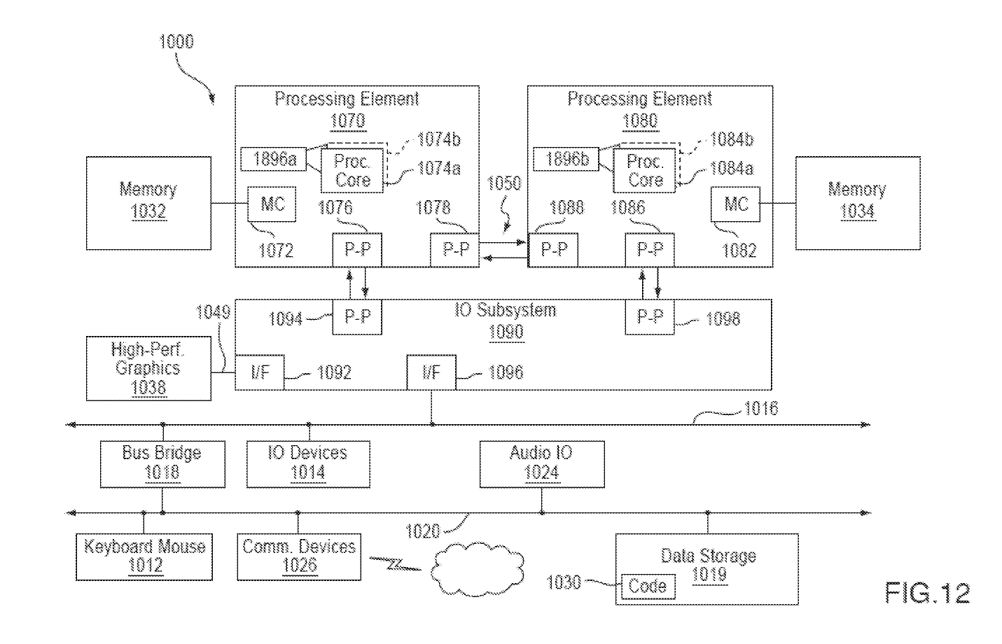

Referring now to FIG. 12, shown is a block diagram of a system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There may be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 12, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 12, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 12, various I/O devices 1014 (e.g., fluidic actuators, switches, keypads, tactile elements, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, an array of tactile elements, keyboard or mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method already discussed with respect to FIG. 6 or any embodiment herein, and may be similar to the code 2130 (FIG. 10), already discussed. Further, an audio I/O 1024 may be coupled to second bus 1020.

Note that other embodiments are contemplated. For example, instead of the point-to-point architecture of FIG. 12, a system may implement a multi-drop bus or another such communication topology. Also, the elements of FIG. 12 may alternatively be partitioned using more or fewer integrated chips than shown in FIG. 12.

Embodiments disclosed herein may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner.

Examples of a wearable device also may include apparatus containing electronic processors that are arranged to be worn by a person and integrated into a wearable structure such as a wristband, glove, ring, eyeglasses, belt-clip or belt, arm-band, shoe, hat, shirt, undergarment, outer garment, clothing generally, and additionally fashion accessories such as wallets, purses, umbrellas etc. In embodiments, for example, a wearable device may be implemented as all or part of a smart phone capable of executing computer applications, as well as voice communications and/or data communications.

### Additional Notes and Examples

Example 1 may include a system to provide a user interface comprising a wearable device with which is integrated a plurality of tactile elements, each of said tactile elements having an active state and an inactive state, a pattern generator module to define a physical pattern of tactile elements to place in an active state, wherein the pattern generator module is to permit variation of the physical pattern, and sensors to determine at least one of an orientation of the wearable device and a location of the wearable device.

Example 2 may include the system of Example 1, further comprising a wireless communications link connecting the wearable device to a network.

Example 3 may include the system of Examples 1 or 2, further comprising a plurality of wearable devices in communication with one another.

Example 4 may include the system of Example 1, wherein the tactile elements each comprise a chamber configured to contain a quantity of pressurizable fluid, the chamber having an overlying flexible portion to bulge out when the fluid is pressurized, further comprising at least one fluid reservoir in fluidic communication with the tactile elements and at least one pump to pressurize the fluid.

Example 5 may include the system of any one of Examples 1, 2, or 4, wherein the physical pattern varies with information provided by at least one of an orientation of the wearable device and a location of the wearable device.

Example 6 may include the system of Example 1, further comprising a display over which some of the tactile elements are arrayed.

Example 7 may include a method of activating tactile elements on a wearable device user interface, comprising generating a logical pattern of tactile elements, and using the logical pattern to define a physical pattern of active tactile elements, wherein both the logical pattern and the physical pattern are variable.

Example 8 may include the method of Example 7, wherein the user interface comprises outer facing and inner facing arrays of tactile elements, wherein both arrays are independently addressable.

Example 9 may include the method of Examples 7 or 8, including determining the orientation of the user interface, and forming a physical pattern of active tactile elements in dependence upon said orientation.

Example 10 may include the method of Examples 7 or 8, including determining a geo-location of the user interface, and forming a physical pattern of active tactile elements in dependence upon said geo-location.

Example 11 may include the method of Example 7, wherein the logical pattern is determined based on information that is obtained remotely from the user interface.

Example 12 may include the method of Examples 7 or 8, including determining a context in which the wearable device is used, and activating groups of tactile elements based on the context.

Example 13 may include the method of Examples 7 or 8, wherein the tactile elements are activated in a pattern that forms a message.

Example 14 may include the method of Example 7, wherein the tactile elements are not activated unless the wearable device is touched by a user.

Example 15 may include at least one computer readable storage medium comprising a set of instructions which, when executed by a computing device, cause the computing device to generate a logical pattern of tactile elements in an array of tactile elements to be activated, and use the logical pattern to define a physical pattern of active tactile elements, wherein both the logical pattern and the physical pattern are variable.

Example 16 may include the at least one computer readable storage medium of Example 15, wherein the instructions, when executed, cause a computing device to address an outer array and an inner facing array of tactile elements.

Example 17 may include the at least one computer readable storage medium of Example 15, wherein the instructions, when executed, cause a computing device to determine an orientation of a user interface, and form a physical pattern of active tactile elements on said interface in dependence upon said orientation.

Example 18 may include the at least one computer readable storage medium of any of Examples 14-17, wherein the instructions, when executed, cause a computing device to determine the geo-location of the interface, and form a physical pattern of active tactile elements on said interface in dependence upon said geo-location.

Example 19 may include the at least one computer readable storage medium of Example 15, wherein the instructions, when executed, cause a computing device to determine the logical pattern based on information determined remotely.

Example 20 may include an apparatus to provide a user interface comprising first and second layers of tactile elements in back-to-back proximity to one another, each of said tactile elements having an active state and an inactive state, and a control module to generate a physical pattern of active tactile elements for at least one of the layers.

Example 21 may include the apparatus of Example 21, wherein the control module is further able to generate a logical pattern of tactile element activations, wherein the physical pattern of activations is based on the logical pattern, and wherein both the physical pattern and the logical pattern are variable.

Example 22 may include the apparatus of Examples 20 or 21, comprising sensors associated with the plurality of tactile elements.

Example 23 may include the apparatus of Example 22, wherein the sensors are to detect infrared radiation and further comprising a sensor module to enable selected tactile elements to be placed into an active state when detected infrared radiation rises above a threshold.

Example 24 may include the apparatus of Example 20, wherein the tactile elements are capable of being individually addressable.

Example 25 may include the apparatus of Examples 20 or 21, further comprising a wearable device article to which the tactile elements are attached.

Example 26 may include the apparatus of Example 20, wherein the first layer of tactile elements has sensors that differ from sensors in the second layer of tactile elements.

Example 27 may include the apparatus of Examples 20 or 21, further comprising sensors to determine at least one of the orientation of the apparatus and the location of the apparatus.

Example 28 may include the apparatus of Examples 20 or 26, further comprising a display over which some of the tactile elements are arrayed.

Example 29 may include the apparatus of Example 20, wherein the tactile elements each comprise a chamber for containing a quantity of pressurizable fluid, the chamber having an overlying flexible portion that bulges out when the fluid is pressurized, further comprising at least one fluid reservoir in fluidic communication with the tactile elements and at least one pump to pressurize the fluid.

Example 30 may include the apparatus of Example 20, further comprising an actuator module to activate the tactile elements belonging to the physical pattern, and wherein the control module further comprises a memory module, a sensor module, a processor module to generate a logical pattern of tactile element activations, and a pattern generator module to map the logical pattern onto a physical pattern of tactile element activations.

Example 31 may include a wearable device comprising first and second layers of tactile elements in back-to-back proximity to one another, each of said tactile elements having an active state and an inactive state, means for generating a logical pattern of active tactile elements, means for generating a physical pattern of active tactile elements, means for determining the orientation or location of the device, and means for varying the physical pattern based on the orientation or location of the device.

Example 32 may include the wearable device of Example 31, further comprising means for wirelessly communicating with another device.

Example 33 may include the wearable device of Examples 31 or 32, further comprising sensors capable of detecting the proximity of a human finger, and means for activating the tactile elements when the finger is near the sensors.

Example 34 may include the wearable device of Example 31, wherein the means for generating a physical pattern of tactile elements does not do so unless a user first touches one of the layers of tactile elements.

Example 35 may include a method of activating tactile elements on a wearable device user interface, comprising generating a logical pattern of tactile elements, using the logical pattern to define a physical pattern of active tactile elements, and varying the physical pattern in dependence upon the orientation of the user interface.

Example 36 may include the method of Example 35, wherein the logical pattern is received by the wearable device user interface through a wireless channel.

Example 37 may include the method of Example 35, wherein a plurality of wearable devices are in communication with one another.

Example 38 may include the method of any one of Examples 35, 36 or 37, including using Global Positioning System coordinates to form the physical pattern.

Example 39 may include the method of Example 38, wherein the physical pattern conveys directional information.

Example 40 may include the method of Example 35, further including game play.

Example 41 may include the method of Example 35, wherein the physical pattern conveys a message.

Example 42 may include the method of Example 41, wherein the physical pattern is conveyed via a clockwise or counterclockwise activation of tactile elements.

Example 43 may include the method of Example 41, wherein the physical pattern is conveyed by activating a cascading series of tactile elements.

Example 44 may include the method of Example 35, further comprising determination of a user context, and wherein the shape or size of the physical pattern depends on the context.

Example 45 may include the method of Example 35, wherein accelerometer data is used to determine an activity state of a user, and wherein the number or pattern of tactile elements activated is selected in dependence on the activity state.

Example 46 may include the method of Examples 35 or 44, wherein tactile elements are activated in groups to provide a user with the tactile sensation of larger buttons.

Example 47 may include a method of navigating via a wearable device user interface that comprises an array of buttons, each of said buttons having an active state and an inactive state, comprising forming a pattern of buttons to activate, and activating buttons defined by the pattern, wherein the pattern is at least partly based on directions at least partially based on Global Positioning System coordinates.

Example 48 may include the method of Example 47, wherein the wearable device user interface has an inner side and has an array of buttons on the inner side.

Example 49 may include a user interface comprising an array of addressable tactile elements having an active state and an inactive state, each of said tactile elements further having a position in the array, a sensor element in proximity to each tactile element, means for selecting a pattern of said tactile elements and selectively placing the tactile elements into an active state, means for placing at least one sensor element into an inactive state, and means for varying the pattern and the tactile elements that are in an active state.

Example 50 may include the user interface of Example 49, further comprising a wearable device that is in the form of a hat, shirt, undergarment, belt, wristband, watch, or glasses.

Example 51 may include the user interface of Example 49, wherein the user interface has an inner side and the array of addressable tactile elements is on the inner side.

Example 52 may include the user interface of Example 49, wherein the user interface has an outer side and the array of addressable tactile elements is on the outer side.

Example 53 may include the user interface of Example 49, comprising two arrays of addressable tactile elements, wherein the user interface has an inner side and an outer side, and wherein one said array is on the inner side, and one side array is on the outer side.

Example 54 may include the user interface of Example 53, wherein the two arrays of addressable tactile elements are independently addressable with respect to one another.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

As used herein, the term “fluidic” may encompass the term “microfluidic” and the field of microfluidics, depending on component size.

Example sizes/models/values/ranges may have been given, although embodiments are not limited to the same. As manufacturing techniques mature over time, it is expected that devices of smaller size and smaller tactile element size may be manufactured. In addition, well known electrical or fluidic components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system to provide a user interface comprising:
a wearable device with which is integrated a plurality of tactile elements, each of said tactile elements having an active state and an inactive state;
a pattern generator module to define a physical pattern of tactile elements to place in an active state, wherein the pattern generator module is to permit variation of the physical pattern; and
sensors to determine at least one of an orientation of the wearable device and a location of the wearable device.

2. The system of claim 1, further comprising a wireless communications link connecting the wearable device to a network.

3. The system of claim 1, further comprising a plurality of wearable devices in communication with one another.

4. The system of claim 1, wherein the tactile elements each comprise a chamber configured to contain a quantity of pressurizable fluid, the chamber having an overlying flexible portion to bulge out when the fluid is pressurized, further comprising at least one fluid reservoir in fluidic communication with the tactile elements and at least one pump to pressurize the fluid.

5. The system of claim 1, wherein the physical pattern varies with information provided by at least one of an orientation of the wearable device and a location of the wearable device.

6. The system of claim 1, further comprising a display over which some of the tactile elements are arrayed.

7. A method of activating tactile elements on a wearable device user interface, comprising:
generating a logical pattern of tactile elements; and
using the logical pattern to define a physical pattern of active tactile elements,
wherein both the logical pattern and the physical pattern are variable.

8. The method of claim 7, wherein the user interface comprises outer facing and inner facing arrays of tactile elements, wherein both arrays are independently addressable.

9. The method of claim 7, including:
determining the orientation of the user interface; and
forming a physical pattern of active tactile elements in dependence upon said orientation.

10. The method of claim 7, including determining a geo-location of the user interface, and forming a physical pattern of active tactile elements in dependence upon said geo-location.

11. The method of claim 7, wherein the logical pattern is determined based on information that is obtained remotely from the user interface.

12. The method of claim 7, including determining a context in which the wearable device is used, and activating groups of tactile elements based on the context.

13. The method of claim 7, wherein the tactile elements are activated in a pattern that forms a message.

14. The method of claim 7, wherein the tactile elements are not activated unless the wearable device is touched by a user.

15. At least one computer readable storage medium comprising a set of instructions which, when executed by a computing device, cause the computing device to:
generate a logical pattern of tactile elements in an array of tactile elements to be activated; and
use the logical pattern to define a physical pattern of active tactile elements,
wherein both the logical pattern and the physical pattern are variable.

16. The at least one computer readable storage medium of claim 15, wherein the instructions, when executed, cause a computing device to address an outer array and an inner facing array of tactile elements.

17. The at least one computer readable storage medium of claim 15, wherein the instructions, when executed, cause a computing device to determine an orientation of a user interface, and form a physical pattern of active tactile elements on said interface in dependence upon said orientation.

18. The at least one computer readable storage medium of claim 14, wherein the instructions, when executed, cause a computing device to determine the geo-location of the interface, and form a physical pattern of active tactile elements on said interface in dependence upon said geo-location.

19. The at least one computer readable storage medium of claim 15, wherein the instructions, when executed, cause a computing device to determine the logical pattern based on information determined remotely.

20. An apparatus to provide a user interface comprising:
first and second layers of tactile elements in back-to-back proximity to one another, each of said tactile elements having an active state and an inactive state; and
a control module to generate a physical pattern of active tactile elements for at least one of the layers.

21. The apparatus of claim 21 wherein the control module is further able to generate a logical pattern of tactile element activations, wherein the physical pattern of activations is based on the logical pattern, and wherein both the physical pattern and the logical pattern are variable.

22. The apparatus of claim 20, comprising:
sensors associated with the plurality of tactile elements.

23. The apparatus of claim 22, wherein the sensors are to detect infrared radiation and further comprising a sensor module to enable selected tactile elements to be placed into an active state when detected infrared radiation rises above a threshold.

24. The apparatus of claim 20, wherein the tactile elements are capable of being individually addressable.

25. The apparatus of claim 20, further comprising a wearable device article to which the tactile elements are attached.

26. The apparatus of claim 20, wherein the first layer of tactile elements has sensors that differ from sensors in the second layer of tactile elements.

27. The apparatus of claim 20, further comprising sensors to determine at least one of the orientation of the apparatus and the location of the apparatus.

28. The apparatus of claim 20, further comprising a display over which some of the tactile elements are arrayed.

29. The apparatus of claim 20, wherein the tactile elements each comprise a chamber for containing a quantity of pressurizable fluid, the chamber having an overlying flexible portion that bulges out when the fluid is pressurized, further comprising:
at least one fluid reservoir in fluidic communication with the tactile elements and at least one pump to pressurize the fluid.

30. The apparatus of claim 20, further comprising an actuator module to activate the tactile elements belonging to the physical pattern, and wherein the control module further comprises a memory module, a sensor module, a processor module to generate a logical pattern of tactile element activations, and a pattern generator module to map the logical pattern onto a physical pattern of tactile element activations.
